(19) United States
(12) Patent Application Publication
(10) Pub. No.: US 2026/0246499 A1
(43) Pub. Date: Aug. 20, 2026

(54) COMMUNICATION METHOD AND COMMUNICATIONS DEVICE

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/647,786

(22) Filed: Apr. 14, 2026

Related U.S. Application Data
(63) Continuation of application No. PCT/CN2024/134201, filed on Nov. 25, 2024.

(51) Int. Cl. H04B 7/04; H04B 7/06

(52) U.S. Cl. CPC H04B 7/04013; H04B 7/0617

(57) ABSTRACT

A communication method and a communications device are provided. One example method includes: constructing a first optimization model for a cell-free network, wherein the cell-free network comprises an access point and a reconfigurable intelligence surface (RIS), wherein the first optimization model indicates an energy efficiency of the cell-free network, and an optimization variable of the first optimization model comprises a configuration parameter of the RIS and a beamforming parameter of the access point; and configuring the RIS and the access point based on a solution of the first optimization model.

### CROSS-REFERENCE TO RELATED APPLICATIONS

This application is a continuation of International Application No. PCT/CN2024/134201, filed on Nov. 25, 2024, the disclosure of which is hereby incorporated by reference in its entirety.

### TECHNICAL FIELD

The present application relates to the field of communications technologies, and more particularly, to a communication method and a communications device.

### BACKGROUND

A reconfigurable intelligence surface (reconfigurable intelligence surface, RIS) may be introduced to a cell-free network, to improve communication security in the cell-free network. After the RIS is introduced to the cell-free network, how to optimize energy utilization efficiency while ensuring communication security, that is, how to optimize secrecy energy efficiency of the cell-free network is a technical problem that needs to be resolved.

### SUMMARY

The present application provides a communication method and a communications device. Various aspects of the present application are described below.

According to a first aspect, a communication method is provided, the method is applied to a cell-free network including an access point and an RIS, and the method includes: constructing a first optimization model for the cell-free network, where the first optimization model is used to indicate secrecy energy efficiency of the cell-free network, and an optimization variable of the first optimization model includes a configuration parameter of the RIS and a beamforming parameter of the access point; and configuring the RIS and the access point based on a solution of the first optimization model.

According to a second aspect, a communications device is provided, the device is applied to a cell-free network including an access point and an RIS, and the device includes: a construction module, constructing a first optimization model for the cell-free network, where the first optimization model is used to indicate secrecy energy efficiency of the cell-free network, and an optimization variable of the first optimization model includes a configuration parameter of the RIS and a beamforming parameter of the access point; and a configuration module, configuring the RIS and the access point based on a solution of the first optimization model.

According to a third aspect, a communications device is provided and includes a memory and a processor, where the memory is configured to store a program, and the processor is configured to invoke the program in the memory, to cause the communications device to execute the method according to the first aspect.

According to a fourth aspect, an apparatus is provided, and the apparatus includes a processor configured to invoke a program from a memory, to cause the apparatus to execute the method according to the first aspect.

According to a fifth aspect, a chip is provided, and the chip includes a processor configured to invoke a program from a memory, to cause a device on which the chip is installed to execute the method according to the first aspect.

According to a sixth aspect, a computer-readable storage medium is provided, and the computer-readable storage medium stores a program that causes a computer to execute the method according to the first aspect.

According to a seventh aspect, a computer program product is provided, and the computer program product includes a program that causes a computer to execute the method according to the first aspect.

According to an eighth aspect, a computer program is provided, where the computer program causes a computer to execute the method according to the first aspect.

In embodiments of the present application, for a cell-free network in which an RIS is introduced, a first optimization model indicating secrecy energy efficiency of the cell-free network may be constructed, and an RIS and an access point in the cell-free network are configured based on a solution of the first optimization model, so that the secrecy energy efficiency of the cell-free network is optimized while communication security is ensured.

### BRIEF DESCRIPTION OF THE DRAWINGS

To describe technical solutions in embodiments of the present application or a conventional technology more clearly, accompanying drawings required for describing the embodiments or the conventional technology are briefly described below. Apparently, the accompanying drawings described below show only some of the embodiments of the present application, and other accompanying drawings obtained from these accompanying drawings by a person skilled in the art shall fall within the protection scope of the present application.

FIG. 1 is an example diagram of an architecture of a cellular network in a related technology according to an embodiment of the present application.

FIG. 2 is an example diagram of an architecture of a cell-free network in a related technology according to an embodiment of the present application.

FIG. 3 is an example diagram of a structure of an RIS in a related technology according to an embodiment of the present application.

FIG. 4 is an example diagram of an architecture of a cell-free network assisted by a single functional reconfigurable intelligence surface (single functional reconfigurable intelligence surface, SF-RIS) according to an embodiment of the present application.

FIG. 5 is an example diagram of an architecture of a cell-free network assisted by a multi-functional reconfigurable intelligence surface (multi-functional reconfigurable intelligence surface, MF-RIS) according to an embodiment of the present application.

FIG. 6 is a schematic flowchart of a method for wireless communication according to an embodiment of the present application.

FIG. 7 is another schematic flowchart of a method for wireless communication according to an embodiment of the present application.

FIG. 8 is another schematic flowchart of a method for wireless communication according to an embodiment of the present application.

FIG. 9 is another schematic flowchart of a method for wireless communication according to an embodiment of the present application.

FIG. 10 is a schematic structural diagram of a device for wireless communication according to an embodiment of the present application.

FIG. 11 is a schematic structural diagram of a communications apparatus according to an embodiment of the present application.

### DETAILED DESCRIPTION OF THE EMBODIMENTS

The following clearly and thoroughly describes technical solutions in embodiments of the present application with reference to the accompanying drawings for the embodiments of the present application. Apparently, the described embodiments are merely some rather than all of the embodiments of the present application. All other embodiments obtained from the embodiments of the present application by a person skilled in the art should fall within the protection scope of the present application.

It should be understood that terms used in the specification of the present application are merely used to describe specific embodiments, but are not intended to limit the present application. Singular forms “One”, “a”, and “the” used in the specification and the appended claims of the present application are intended to include plural forms, unless otherwise specified in the context clearly.

Embodiments of the present application relate to a cell-free network and an RIS. For ease of understanding, the cell-free network and the RIS related to the embodiments of the present application are first introduced with reference to accompanying drawings.

### Cell-Free Network

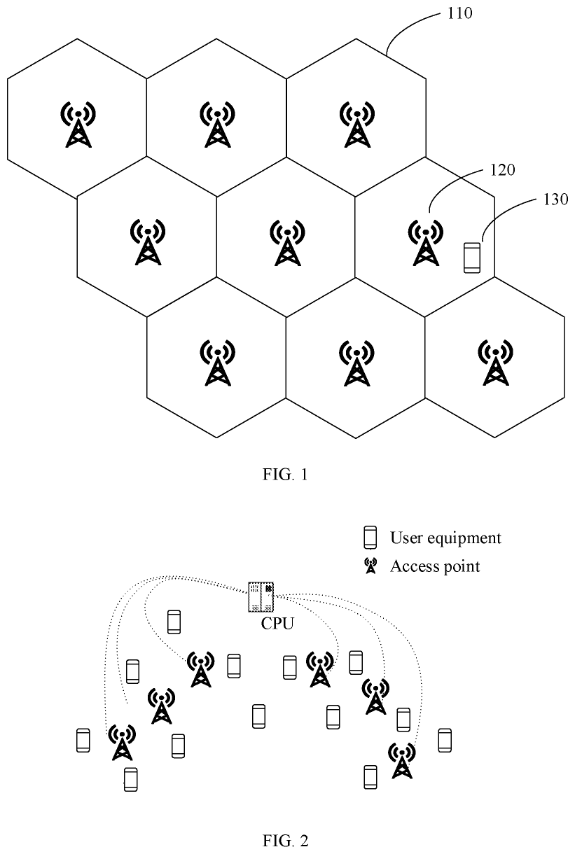

In conventional mobile communication, a cellular network technology is used. FIG. 1 is an example diagram of an architecture of a cellular network in a related technology according to an embodiment of the present application. In the cellular network, a service area may be divided into a plurality of cells 110. A cell 110 may be understood as a specific geographic area. Each cell 110 may include a network device 120 and a user equipment 130. The network device 120 may provide network coverage for a cell 110 in which the network device 120 is located, and may communicate with a user equipment 130 located in the cell 110. The user equipment 130 may access a network (for example, a wireless network) by using the network device 120. The cell 110 is generally a regular hexagon, and therefore, the entire network may be referred to as a cellular network. In the cellular network, spectrum utilization is usually improved by using a frequency multiplexing technology, that is, a same frequency resource is used in different cells. However, such a method may cause mutual interference of signals between adjacent cells.

To eliminate interference between adjacent cells in the cellular network so as to improve a network capacity, a cell-free network technology is proposed. FIG. 2 is an example diagram of an architecture of a cell-free network in a related technology according to an embodiment of the present application. As shown in FIG. 2, concepts of cell division and cell boundary in a conventional cellular network are abandoned in the cell-free network. Different from a conventional cellular-centric network, a user-equipment-centric transmission design is used in the cell-free network. In the cell-free network, a plurality of access points may cooperatively provide a service for each user equipment. The user equipment may be connected to a network by using an access point. To provide seamless coverage for the user equipment, a large quantity of access points may be deployed in the cell-free network. In some cases, the access point may also be referred to as a base station. In the cell-free network, a central processing unit (central processing unit, CPU) may be further included. The CPU may be connected to all antennas on an access point by using a cable. The CPU may be configured to perform one or more of the following operations: processing a baseband signal, calculating a beamforming signal, performing signal detection and precoding, or processing signals transmitted from a plurality of access points.

The user equipment in the cell-free network may also be referred to as a terminal device, an access terminal, a subscriber unit, a subscriber station, a mobile site, a mobile station (mobile station, MS), a mobile terminal, a remote station, a remote terminal, a mobile device, a user terminal, a terminal, a wireless communications device, a user agent, or a user apparatus.

A user equipment in embodiments of the present application may include a device providing a user with voice and/or data connectivity and capable of connecting people, objects, and machines, such as a handheld device or vehicle-mounted device having a wireless connection function. The user equipment in the embodiments of the present application may be a mobile phone, a tablet computer, a notebook computer, a palmtop computer, a mobile internet device, a wearable device, a virtual reality device, an augmented reality device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like.

The user equipment in the cell-free network may include an authorized user equipment and an unauthorized user equipment. The authorized user equipment herein may be understood as a device that is authenticated and complies with regulations and standards of a communications network. The authorized user equipment performs communication based on a specified rule and protocol, and generally does not pose a threat to the communications network.

The unauthorized user equipment may be understood as an unauthorized or maliciously modified device. The unauthorized user equipment may obtain or assist in obtaining a telecommunications service without permission of a telecommunications service provider. The unauthorized user equipment may also hide its real identity or location, thus bypassing normal network access control, which may pose a threat to the communications network. In the cell-free network, due to a broadcast characteristic inherent in a wireless channel, any user equipment within coverage of an access point can receive a signal, and consequently an unauthorized user equipment may receive a signal transmitted by the access point to an authorized user equipment. In other words, an unauthorized user may eavesdrop, thus increasing a risk of information leakage in the cell-free network. Therefore, communication security is a challenge to the cell-free network.

### Reconfigurable Intelligence Surface

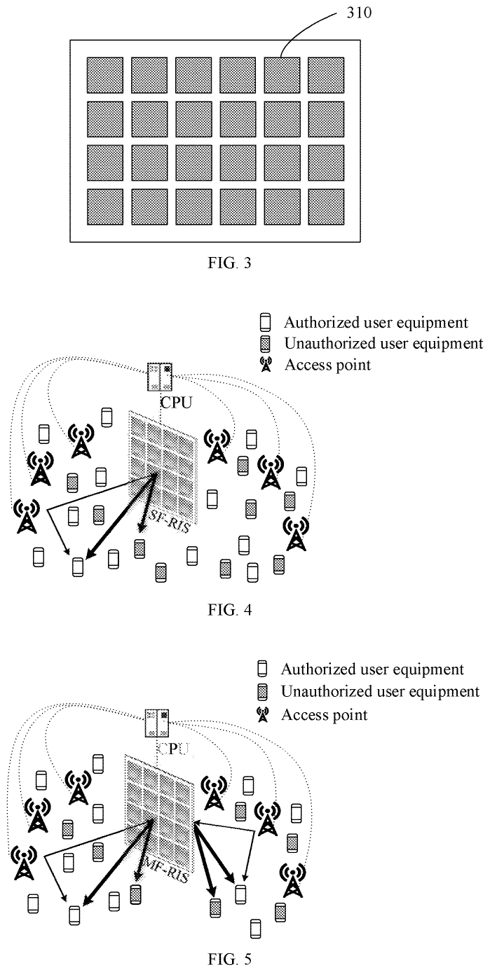

FIG. 3 is an example diagram of a structure of an RIS in a related technology according to an embodiment of the present application. As shown in FIG. 3, the RIS may be considered as a two-dimensional array including a large quantity of low-cost reconfigurable units 310. The reconfigurable unit 310 may include an adjustable element. The adjustable element herein may be for example a phase shifter. By adjusting the adjustable element, a phase and/or an amplitude of the reconfigurable unit 310 may be adjusted, so that an electromagnetic characteristic of the entire RIS can be adjusted, thereby implementing adjustment and control of a wireless channel. In other words, the RIS may be used to reconstruct a radio environment based on a requirement. If the RIS is introduced to a communications network, with assistance of the RIS, signals from different links may be superposed at some locations to enhance signal strength, and canceled or weakened at other locations to decrease signal strength. By using the above characteristics of the RIS, the RIS may be introduced to a cell-free network to enhance signal strength at an authorized user equipment and decrease signal strength at an unauthorized user equipment, thereby enhancing secure reception of the authorized user equipment and suppressing information leakage to the unauthorized user equipment. In other words, the RIS may guarantee communication security of the cell-free network in an economical manner.

The RIS may be divided into an SF-RIS and an MF-RIS based on different functions. The SF-RIS may be used to reflect a signal. By adjusting a phase of a reconfigurable unit in the SF-RIS, a direction of a reflected wave may be changed, so that adjustment and control of a wireless signal propagation path can be implemented. In addition to reflecting a signal, the MF-RIS may be further used to refract and/or amplify the signal. For example, a reconfigurable unit in the MF-RIS may include an amplifier, so as to amplify a signal. By adjusting a phase of the reconfigurable unit in the MF-RIS, both a direction of a reflected wave and a direction of a transmitted wave may be changed, so that adjustment and control of a wireless signal propagation path can be implemented. By adjusting an amplitude coefficient of the reconfigurable unit in the MF-RIS, adjustment and control of an amplification multiple of a wireless signal may be implemented.

As mentioned above, to provide seamless coverage for a user equipment, a large quantity of access points are deployed in the cell-free network, which may cause relatively large network energy consumption. For the cell-free network in which the RIS is introduced, how to improve energy utilization efficiency as much as possible while ensuring communication security, that is, how to maximize secrecy energy efficiency is a technical problem that needs to be resolved.

In view of the foregoing problem, embodiments of the present application provide a communication method. According to this method, a value of a configuration parameter of an RIS and a value of a beamforming parameter of an access point that maximize the secrecy energy efficiency may be solved, and the RIS and the access point are configured based on the value of the configuration parameter and the value of the beamforming parameter, so that maximum secrecy energy efficiency of a cell-free network can be implemented.

The communication method provided in the embodiments of the present application may be applied to a cell-free network assisted by an RIS. For ease of understanding, the following describes in detail the cell-free network assisted by the RIS with reference to FIG. 4 and FIG. 5.

As shown in FIG. 4 and FIG. 5, the cell-free network assisted by the RIS may include A access points, B authorized user equipments, E unauthorized user equipments, one RIS, and one or more CPUs. For detailed description of an access point, an authorized user equipment, and an unauthorized user equipment, reference may be made to related description above, and details are not described herein again. A set of access points may be represented as A={1, 2 . . . , A}, and each access point may be equipped with N antennas. A set of authorized user equipments may be represented as B={1, 2, . . . , B}, and each authorized user equipment may be equipped with a single antenna. A set of unauthorized user equipments may be represented as E={1, 2, . . . , E}, and each unauthorized user equipment may be equipped with a single antenna. The RIS may be used to assist transmission from the A access points to the B authorized user equipments. The RIS may include M reconfigurable units. In the following description, these units may be referred to as RIS units. A set of RIS units may be represented as M={1, 2, . . . , M}. The CPU may be configured to control all access points and the RIS by using an optical fiber or a wireless backhaul. A channel from an access point a to an authorized user equipment b may be represented as h_{ab}^{H}∈ [symbol] ^{1×N}, a channel from the access point a to an unauthorized user equipment e may be represented as hₐₑ∈C^{1×N}, a channel from the access point a to the RIS may be represented as Gₐₛ∈C^{M×N}, a channel from the RIS to the authorized user equipment b may be represented as g_{sb}^{H}∈C^{1×M}, and a channel from the RIS to the unauthorized user equipment e may be represented as gₛₑ^{H}∈C^{1×M}. Channel state information of all channels may be obtained by using an existing channel estimation method. A process in which an element and a parameter involved in the cell-free network assisted by the RIS are mathematically represented may also be referred to as a modeling process for the cell-free network assisted by the RIS.

The RIS herein may be the SF-RIS or the MF-RIS described above. Referring to FIG. 4, when the RIS is the SF-RIS, because the SF-RIS can reflect a signal in the cell-free network, the SF-RIS may guarantee communication security of half space, that is, reflection space. Because user equipments and access points in the cell-free network are distributed across full space, it may be difficult for the SF-RIS to cope with pervasive security threats. In addition, because there are two cascaded subchannels, that is, a subchannel from an access point to the SF-RIS, and a subchannel from the SF-RIS to a user equipment, double attenuation may be caused, and channel gains brought by the SF-RIS to the cell-free network may thus be limited.

Referring to FIG. 5, when the RIS is the MF-RIS, because the MF-RIS can not only reflect a signal in the cell-free network, but also refract a signal in the cell-free network, the MF-RIS may guarantee communication security of full space. The full space may be defined as K={r,t}. When the MF-RIS is used to perform reflection, k=r. When the MF-RIS is used to perform refraction, k=t. In addition, because the MF-RIS can further amplify a signal in the cell-free network, the MF-RIS may provide additional channel gains for the cell-free network.

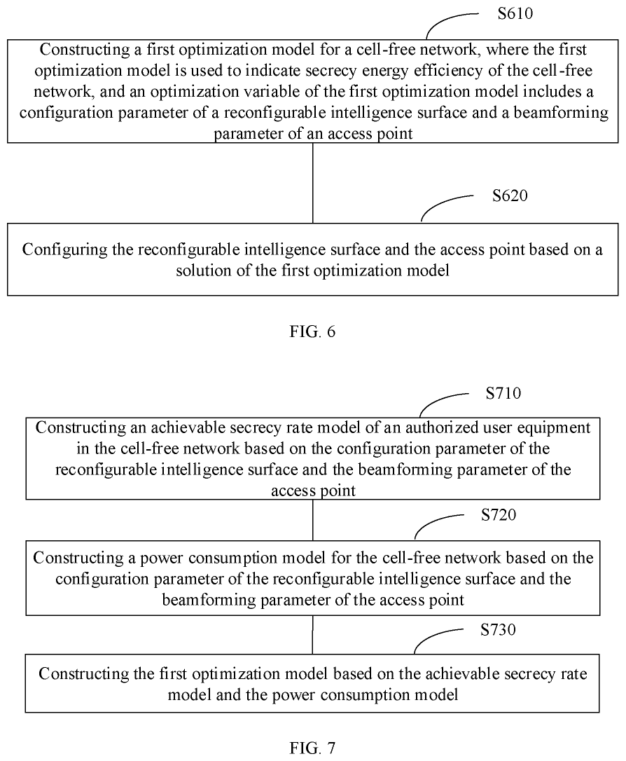

The cell-free network assisted by the RIS is described above, and a method for wireless communication provided in embodiments of the present application is described below with reference to FIG. 6. As shown in FIG. 6, the wireless communication method provided in the embodiments of the present application may include the following steps S610 and S620.

In step S610, a first optimization model is constructed for a cell-free network.

The first optimization model may be used to indicate secrecy energy efficiency of the cell-free network. Therefore, “constructing the first optimization model” may be understood as formulating the secrecy energy efficiency of the cell-free network. The secrecy energy efficiency of the cell-free network may be determined based on an achievable secrecy rate of an authorized user equipment in the cell-free network and power consumption of the cell-free network. Optimization variables of the first optimization model may include a configuration parameter of an RIS and a beamforming parameter of an access point.

The configuration parameter of the RIS may include a phase shift and an amplitude coefficient of a unit in the RIS. For example, when the RIS is an MF-RIS, the configuration parameter of the RIS may be represented as

$${Θ}_{k} = diag ( \sqrt{{β}_{1}^{k}} {e}^{j {θ}_{1}^{k}} , \sqrt{{β}_{2}^{k}} {e}^{j {θ}_{2}^{k}} , … , {e}^{j {θ}_{M}^{k}} ) ,$$

where Θₖ represents a coefficient matrix used by the MF-RIS to perform reflection (k=r) or refraction

$$( k = t ) , {θ}_{m}^{k}$$

represents a phase shift of a m^{th} unit in the MF-RIS, and

$${β}_{m}^{k}$$

presents an amplitude coefficient of the m^{th} unit in the MF-RIS. When the RIS is the MF-RIS, the configuration parameters of the RIS may also be referred to as MF-RIS coefficients.

The beamforming parameter of the access point may include a precoding vector w_{b} at the access point for a user equipment in the cell-free network. For an access point equipped with N antennas, the beamforming parameter of the access point may include a precoding vector at each antenna for the user equipment in the cell-free network, where the user equipment may include an authorized user equipment and an unauthorized user equipment. In other words, the beamforming parameter of the access point may include a precoding vector at each access point a for each authorized user equipment b in the cell-free network and a precoding vector at each access point a for each unauthorized user equipment e in the cell-free network.

In step S620, the RIS and the access point are configured based on a solution of the first optimization model.

After the first optimization model is constructed in step S610, the first optimization model may be solved. The solution of the first optimization model may include a value of the configuration parameter of the RIS and a value of the beamforming parameter of the access point. The RIS and the access point may be configured based on the solution of the first optimization model.

It may be learned from the foregoing description of steps S610 and S620 that, in the embodiments of the present application, a first optimization model indicating secrecy energy efficiency of the cell-free network may be constructed for a cell-free network in which an RIS is introduced, and the RIS and an access point in the cell-free network are configured based on a solution of the first optimization model, so that the secrecy energy efficiency of the cell-free network is optimized while communication security is ensured.

In some implementations, the configuring of the RIS and the access point based on the solution of the first optimization model in Step S62 may include: solving the first optimization model with an optimization objective of maximizing the secrecy energy efficiency, to determine a value of the configuration parameter and a value of the beamforming parameter; and configuring the RIS and the access point based on the value of the configuration parameter and the value of the beamforming parameter.

After the first optimization model is constructed in step S610, the first optimization model may be solved with the optimization objective of maximizing the secrecy energy efficiency, to determine the value of the configuration parameter and the value of the beamforming parameter. The first optimization model herein may also be referred to as an objective function. When the first optimization model is solved, a constraint condition may be set for the first optimization model.

Optionally, in some embodiments, the constraint condition of the first optimization model may include: an output power of the access point is less than or equal to a maximum transmit power of the access point, that is

$${\sum }_{b ∈ B} {‖ {w}_{a b} ‖}^{2} \leq {P}_{A P}^{max} , ∀ a ∈ A ,$$

where w_{ab} represents the precoding vector at the access point a for the authorized user equipment b, and

$${P}_{A P}^{max}$$

represents a maximum transmit power of each access point.

Optionally, in some embodiments, the constraint condition of the first optimization model may include: an output power of the RIS is less than or equal to a maximum output power of the RIS. When the RIS is the MF-RIS, this constraint condition may be represented as

$${P}_{RIS}^{O} + {\sum }_{k ∈ K} {σ}_{0}^{2} {‖ {Θ}_{k} ‖}_{F}^{2} \leq {P}_{RIS}^{max} ,$$

where

$${P}_{RIS}^{O} = {\sum }_{k ∈ K} {\sum }_{a ∈ A} {\sum }_{b ∈ B} {‖ {Θ}_{k} {G}_{as} {w}_{ab} ‖}^{2} ,$$

Gₐₛ represents a channel from the access point a to the MF-RIS, Θₖ represents a coefficient matrix used by the MF-RIS to perform reflection (k=r) or refraction (k=t), w_{ab} represents a precoding vector at the access point a for an authorized user equipment b, and

$${σ}_{0}^{2}$$

represents a power of thermal noise introduced at the MF-RIS.

Optionally, in some embodiments, the constraint condition of the first optimization model may include: a phase shift of a unit in the RIS is greater than or equal to zero and less than 2π, that is,

$${θ}_{m}^{k} ∈ [ 0 , 2 π ) , ∀ k ∈ K , ∀ m ∈ M .$$

Optionally, in some embodiments, the constraint condition of the first optimization model may include: an amplitude coefficient of the unit in the RIS is less than or equal to a maximum amplitude coefficient, that is

$${β}_{m}^{k} ∈ [ 0 , {β}_{max} ] , ∀ k ∈ K , ∀ m ∈ M ,$$

where βₘₐₓ≥1 and represents a maximum amplification factor. The maximum amplification factor herein may be used to indicate a signal amplification capability of the RIS. A larger value of βₘₐₓ indicates a stronger signal amplification capability of the RIS. The signal amplification capability of the RIS may be changed by changing a structure of the RIS, thereby changing a value of βₘₐₓ.

Optionally, in some embodiments, the constraint condition of the first optimization model may include: a sum of amplitude coefficients of units in the RIS is less than or equal to a maximum amplitude coefficient, that is

$${\sum }_{k ∈ K} {β}_{m}^{k} \leq {β}_{max} ,$$

∇m∈M. In other words, the amplitude coefficient of the unit in the RIS needs to meet an energy conservation constraint.

Optionally, in some embodiments, the constraint condition of the first optimization model may include: a rate of the authorized user equipment in the cell-free network meets a preset minimum rate requirement. The rate of the authorized user equipment meeting the preset minimum rate requirement may be understood as the rate of the authorized user equipment being greater than or equal to a preset minimum rate of the user equipment. That is, R_{b}≥Rₘᵢₙ,∇b∈B, where R_{b} represents a rate of the authorized user equipment b, and Rₘᵢₙ represents the preset minimum rate of the authorized user equipment. The preset minimum rate of the authorized user equipment may be understood as a minimum data transmission rate that the authorized user equipment needs to ensure when using a network service.

After the value of the configuration parameter and the value of the beamforming parameter are determined, the RIS and the access point may be configured based on the value of the configuration parameter and the value of the beamforming parameter. “The configuring of the RIS and the access point based on the value of the configuration parameter and the value of the beamforming parameter” may include: configuring the unit in the RIS and an antenna of the access point based on the value of the configuration parameter and the value of the beamforming parameter. The configuring of the RIS and the access point herein may be for example implemented by a CPU in the cell-free network. As mentioned above, when the RIS is the MF-RIS, the configuration parameter may include a phase shift and an amplitude coefficient of each unit in the MF-RIS, and the beamforming parameter may include a precoding vector at each antenna of the access point for each user equipment (including the authorized user equipment and the unauthorized user equipment) in the cell-free network. In this case, the phase shift and the amplitude coefficient of each unit in the MF-RIS may be adjusted to a phase shift and an amplitude coefficient that are obtained by solving, and a precoding vector at each antenna of each access point for each user equipment may be adjusted to be consistent with a precoding vector obtained by solving, so that the secrecy energy efficiency of the cell-free network can be maximized.

As mentioned in step S610, the secrecy energy efficiency of the cell-free network may be determined based on the achievable secrecy rate of the authorized user equipment in the cell-free network and the power consumption of the cell-free network. Therefore, the first optimization model may be constructed based on the achievable secrecy rate of the authorized user equipment in the cell-free network and the power consumption of the cell-free network. In this case, referring to FIG. 7, constructing the first optimization model for the cell-free network in step S610 may include the following steps S710 to S730.

In step S710, an achievable secrecy rate model of an authorized user equipment in the cell-free network is constructed based on the configuration parameter of the RIS and the beamforming parameter of the access point.

The achievable secrecy rate model herein may be used to indicate a sum of achievable secrecy rates of B authorized user equipments in the cell-free network. The sum of the achievable secrecy rates of the B authorized user equipments may be represented as

$${\sum }_{b ∈ B} {R}_{b}^{s} ,$$

where

$${R}_{b}^{s}$$

represents an achievable secrecy rate of the authorized user equipment b.

In step S720, a power consumption model for the cell-free network is constructed based on the configuration parameter of the RIS and the beamforming parameter of the access point.

The power consumption model herein may be used to indicate total power consumption of the cell-free network. The total power consumption of the cell-free network may include the output power of A access points, the output power of the RIS, power consumption of the A access points, power consumption of the B authorized user equipments, and power consumption of the RIS. When the RIS is the MF-RIS, the total power consumption of the cell-free network may be represented as

$${P}_{T} = {δ}_{1} {\sum }_{k ∈ K} ( {\sum }_{a ∈ A} {\sum }_{b ∈ B} ‖ {Θ}_{k} {G}_{as} {w}_{ab} ‖ + {σ}_{0}^{2} {‖ {Θ}_{k} ‖}_{F}^{2} ) + {δ}_{2} {\sum }_{a ∈ A} {\sum }_{b ∈ B} {‖ {w}_{a b} ‖}^{2} + {P}_{C} ,$$

where δ₁ and δ₂ respectively represent reciprocals of energy conversion coefficients at the MF-RIS and each access point, P_{C}=AP_{A}+BP_{B}+2MP_{S}+MP_{Am}, P_{A} represents dissipation power of each access point, P_{B} represents dissipation power of each authorized user equipment, P_{S} represents dissipation power of each phase shifter, and P_{Am} represents power dissipation of each power amplifier.

In step S730, the first optimization model is constructed based on the achievable secrecy rate model and the power consumption model.

After the achievable secrecy rate model is constructed in step S710 and the power consumption model is constructed in step S720, the first optimization model may be constructed based on the achievable secrecy rate model and the power consumption model. For example, when the achievable secrecy rate model is represented as

$${\sum }_{b ∈ B} {R}_{b}^{s} ,$$

and the power consumption model is represented as P_{T}, the first optimization model may be represented as

$$\frac{{\sum }_{b ∈ B} {R}_{b}^{s}}{{P}_{T}} .$$

As mentioned above, in step S710, the achievable secrecy rate model of the authorized user equipment in the cell-free network may be constructed based on the configuration parameter of the RIS and the beamforming parameter of the access point. In some implementations, step S710 may include: determining a first equivalent channel model based on the configuration parameter of the RIS, determining a second equivalent channel model based on the configuration parameter of the RIS, and determining the achievable secrecy rate model based on the beamforming parameter, the first equivalent channel model, and the second equivalent channel model.

The first equivalent channel model herein may be understood as an equivalent channel model from the access point to the authorized user equipment. The first equivalent channel model may include a channel model from the access point to the authorized user equipment and a channel model from the access point via the RIS to the authorized user equipment. The channel model from the access point to the authorized user equipment and the channel model from the access point via the RIS to the authorized user equipment may be added to obtain the first equivalent channel model. The channel model from the access point via the RIS to the authorized user equipment may be represented as

$${g}_{s b}^{H} {Θ}_{k} {G}_{as} ,$$

where

$${g}_{s b}^{H}$$

represents a channel from the RIS to the authorized user equipment b; Θₖ represents a coefficient matrix used by the RIS to perform reflection (k=r) or refraction (k=t), where if the access point a and the authorized user equipment b are on a same side of the RIS, k=r; and if the access point a and the authorized user equipment b are separately on two sides of the RIS, k=t; and Gₐₛ represents a channel from the access point a to the RIS. The first equivalent channel model may be represented

$${\overline{h}}_{ab}^{H} = {h}_{ab}^{H} + {g}_{sb}^{H} {Θ}_{k} {G}_{as} ,$$

where

$${\overline{h}}_{ab}^{H}$$

represents an equivalent channel from the access point a to the authorized user equipment b, and

$${h}_{ab}^{H}$$

represents a channel from the access point a to the authorized user equipment b.

The second equivalent channel model herein may be understood as an equivalent channel model from the access point to the unauthorized user equipment in the cell-free network. The second equivalent channel model may include a channel model from the access point to the unauthorized user equipment and a channel model from the access point via the RIS to the unauthorized user equipment. The channel model from the access point to the unauthorized user equipment and the channel model from the access point via the RIS to the unauthorized user equipment may be added to obtain the second equivalent channel model. The channel model from the access point via the RIS to the unauthorized user equipment may be represented

$${g}_{s e}^{H} {Θ}_{k} {G}_{as} ,$$

where

$${g}_{s e}^{H}$$

represents a channel from the RIS to the unauthorized user equipment e; Θₖ represents the coefficient matrix used by the RIS to perform reflection (k=r) or refraction (k=t), where if the access point a and the unauthorized user equipment e are on a same side of the RIS, k=r; and if the access point a and the unauthorized user equipment e are separately on two sides of the RIS, k=t; and Gₐₛ represents the channel from the access point a to the RIS. The second equivalent channel model may be represented as

$${\overline{h}}_{a e}^{H} = {h}_{a e}^{H} + {g}_{s e}^{H} {Θ}_{k} {G}_{as} ,$$

where

$${\overline{h}}_{ae}^{H}$$

represents an equivalent channel from the access point a to the unauthorized user equipment e, and

$${h}_{a e}^{H}$$

represents a channel from the access point a to the unauthorized user equipment e.

After the first equivalent channel model and the second equivalent channel model are determined, the achievable secrecy rate model may be determined based on the beamforming parameter, the first equivalent channel model, and the second equivalent channel model.

In some implementations, the determining of the achievable secrecy rate model based on the beamforming parameter, the first equivalent channel model, and the second equivalent channel model may include: determining a first signal to interference plus noise ratio based on the beamforming parameter and the first equivalent channel model; determining a second signal to interference plus noise ratio based on the second equivalent channel model; and determining the achievable secrecy rate model based on the first signal to interference plus noise ratio and the second signal to interference plus noise ratio.

The first signal to interference plus noise ratio may be understood as a signal to interference plus noise ratio existing when the authorized user equipment demodulates a signal transmitted by the access point to the authorized user equipment. Σ_{b∈B}w_{ab}s_{b} may be defined as an outgoing signal of the access point a, where w_{ab} represents the precoding vector at the access point a for the authorized user equipment b, s_{b} represents a transmit symbol of the authorized user equipment b, and satisfies [symbol] {|s_{b}|²}=1. Therefore, a signal received by the authorized user equipment b may be represented as:

$$\begin{matrix}{y}_{b} = {\sum }_{a ∈ A} ( {\overline{h}}_{a b}^{H} {\sum }_{b ∈ B} {w}_{a b} {s}_{b} ) + {\sum }_{k ∈ K} {g}_{s b}^{H} {Θ}_{k} {n}_{0} + {n}_{1} \\ = {\sum }_{a ∈ A} {\overline{h}}_{a b}^{H} {w}_{a b} {s}_{b} + {\sum }_{a ∈ A} ( {\sum }_{j = 1 , j \neq b}^{B} {\overline{h}}_{a b}^{H} {w}_{a j} {s}_{j} ) + {\sum }_{k ∈ K} {g}_{s b}^{H} {Θ}_{k} {n}_{0} + {n}_{1} \\ = {\overline{h}}_{b}^{H} {w}_{b} {s}_{b} + {\sum }_{j = 1 , j \neq b}^{B} {\overline{h}}_{b}^{H} {w}_{j} {s}_{j} + {\sum }_{k ∈ K} {g}_{s b}^{H} {Θ}_{k} {n}_{0} + {n}_{1} ,\end{matrix}$$

where

$${\overline{h}}_{b} = {[ {\overline{h}}_{1 b}^{T} , … , {\overline{h}}_{A b}^{T} ]}^{T} ∈ {ℂ}^{A N \times 1} , {w}_{j} = {[ {w}_{1 j}^{T} , … , {w}_{A j}^{T} ]}^{T} ∈ {ℂ}^{A N \times 1} , {n}_{0} ∼ CN ( {0}_{M} , {σ}_{0}^{2} {I}_{M} )$$

represent the thermal noise introduced at the MF-RIS and has a power of

$${σ}_{0}^{2} , and {n}_{1} ∼ CN ( 0 , {σ}_{1}^{2} )$$

represents additive white Gaussian noise at the authorized user equipment and has a power of

$${σ}_{1}^{2} .$$

Therefore, the first signal to interference plus noise ratio may be represented as

$${γ}_{b} = \frac{{\vert {\overline{h}}_{b}^{H} {w}_{b} \vert}^{2}}{{\sum }_{j = 1 , j \neq b}^{B} {\vert {\overline{h}}_{b}^{H} {w}_{j} \vert}^{2} + {\sum }_{k ∈ K} {σ}_{0}^{2} {‖ {g}_{s b}^{H} {Θ}_{k} ‖}^{2} + {σ}_{1}^{2}} ,$$

where γ_{b} represents a signal to interference plus noise ratio existing when the authorized user equipment b demodulates a signal transmitted by the access point to the authorized user equipment b.

The second signal to interference plus noise ratio herein may be understood as a signal to interference plus noise ratio existing when the unauthorized user equipment demodulates the signal transmitted by the access point to the authorized user equipment. Similar to the process of determining the first signal to interference plus noise ratio, a signal obtained by the unauthorized user equipment e through eavesdropping on information for the authorized user equipment b may be represented as:

$${y}_{e b} = {\overline{h}}_{e}^{H} {w}_{b} {s}_{b} + {\sum }_{j = 1 , j \neq b}^{B} {\overline{h}}_{e}^{H} {w}_{j} {s}_{j} + {\sum }_{k ∈ K} {g}_{s e}^{H} {Θ}_{k} {n}_{0} + {n}_{2} ,$$

where

$${\overline{h}}_{e} = [ {\overline{h}}_{1 e}^{T} , … , {\overline{h}}_{A e}^{T} ] ∈ {ℂ}^{A N \times 1} , and {n}_{2} ∼ CN ( 0 , {σ}_{2}^{2} )$$

represents additive white Gaussian noise with a power of

$${σ}_{2}^{2}$$

at the unauthorized user equipment.

Therefore, the second signal to interference plus noise ratio may be represented as

$${γ}_{e b} = \frac{{\vert {\overline{h}}_{e}^{H} {w}_{b} \vert}^{2}}{{\sum }_{j = 1 , j \neq b}^{B} {\vert {\overline{h}}_{e}^{H} {w}_{j} \vert}^{2} + {\sum }_{k ∈ K} {σ}_{0}^{2} {‖ {g}_{s e}^{H} {Θ}_{k} ‖}^{2} + {σ}_{2}^{2}} ,$$

where γ_{eb} represents a signal to interference plus noise ratio existing when the unauthorized user equipment e demodulates the signal transmitted by the access point to the authorized user equipment b.

After the first signal to interference plus noise ratio and the second signal to interference plus noise ratio are determined, the achievable secrecy rate model may be determined based on the first signal to interference plus noise ratio and the second signal to interference plus noise ratio. The achievable secrecy rate

$${R}_{b}^{s}$$

of the authorized user equipment b may be determined based on the signal to interference plus noise ratio γ_{b} existing when the authorized user equipment b demodulates the signal transmitted by the access point to the authorized user equipment b and the signal to interference plus noise ratio γ_{eb} existing when the unauthorized user equipment e demodulates the signal transmitted by the access point to the authorized user equipment b, and then the achievable secrecy rate model of the B authorized user equipments in the cell-free network is determined based on the achievable secrecy rate

$${R}_{b}^{s}$$

the authorized user equipment b. The achievable secrecy rate

$${R}_{b}^{s}$$

the authorized user equipment b may be represented as:

$${R}_{b}^{s} = {[ {R}_{b} - {max}_{e ∈ E} {R}_{e b} ]}^{+} = {[ {log}_{2} ( 1 + {γ}_{b} ) - {max}_{e ∈ E} ( {log}_{2} ( 1 + {γ}_{e b} ) ) ]}^{+} ,$$

where R_{b}=log₂(1+γ_{b}), R_{eb}=log₂(1+γ_{eb}), and an operator [x]⁺=max{x,0}. Due to a non-negative characteristic of the optimal secrecy rate, the operator may be omitted subsequently.

After the foregoing operations, the first optimization model may be represented as:

$${max}_{{\{ {w}_{b} , {Θ}_{k} \}}_{}} \frac{{\sum }_{b ∈ B} {R}_{b}^{s}}{{P}_{T}} s . t . {\sum }_{b ∈ B} {‖ {w}_{a b} ‖}^{2} \leq {P}_{A P}^{max} , ∀ a ∈ A , {P}_{RIS}^{O} + {\sum }_{k ∈ K} {σ}_{0}^{2} {‖ {Θ}_{k} ‖}_{F}^{2} \leq {P}_{RIS}^{max} , {\sum }_{k ∈ K} {β}_{m}^{k} \leq {β}_{max} , ∀ m ∈ M , {β}_{m}^{k} ∈ [ 0 , {β}_{max} ] , {θ}_{m}^{k} ∈ [ 0 , 2 π ) , ∀ k ∈ K , ∀ m ∈ M , {R}_{b} \geq {R}_{min} , ∀ b ∈ B .$$

The above description, in conjunction with the accompanying drawings, provides a detailed explanation of how to construct the first optimization model. The following description details how to solve the first optimization model.

It may be learned from the foregoing description that the first optimization model and the constraint condition of the first optimization model (which is referred to as a first constraint condition below) may be relatively complex. For example, the first optimization model may be in a fractional form, the first constraint condition may include a plurality of constraint conditions, and some constraint conditions may include a complex logarithmic form. Therefore, in a process of solving the first optimization model, the optimization objective for the first optimization model (which is referred to as a first optimization objective below), the first optimization model, and the first constraint condition may be converted based on a first processing manner to a second optimization objective, a second optimization model, and a second constraint condition. The first processing manner may include one or more of the following: introducing a slack variable, introducing an auxiliary variable, performing successive convex approximation on a non-convex constraint, ignoring a rank-one constraint, or using sequential rank-one constraint relaxation.

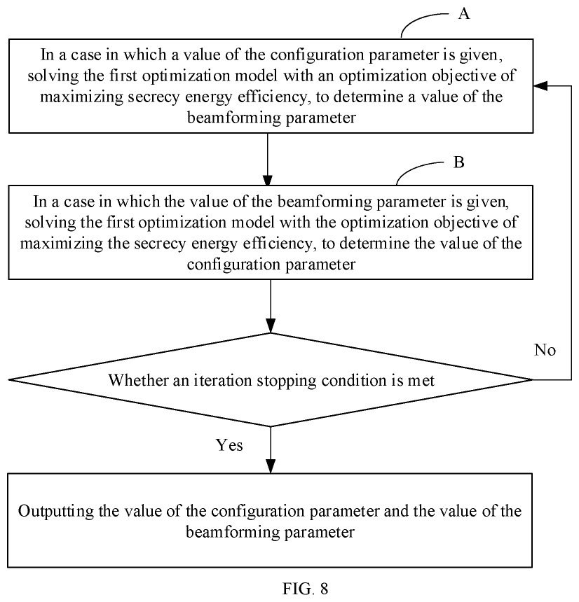

As mentioned above, the optimization variables of the first optimization model may include the configuration parameter of the RIS and the beamforming parameter of the access point. In some implementations, the configuration parameter of the RIS and the beamforming parameter of the access point may be solved in an iterative manner by using a variable replacement method. When the first optimization model is solved by using the variable replacement method, the configuration parameter and the beamforming parameter may be alternately used as the optimization variable in an iteration process. Referring to FIG. 8, the first optimization model may be solved by repeatedly performing an iteration process including the following step A and step B, so as to determine the value of the configuration parameter and the value of the beamforming parameter. A process including step A and step B may be referred to as one iteration process. It should be understood that, in the first iteration process, step A may be performed before step B. In this case, step A is performed before step B in each iteration process. Alternatively, in the first iteration process, step B may be performed before step A. In this case, step B is performed before step A in each iteration process.

Step A may include: in a case in which a value of the configuration parameter is given, solving the first optimization model with an optimization objective of maximizing the secrecy energy efficiency, to determine a value of the beamforming parameter.

In other words, in step A, the value of the configuration parameter may be fixed, and the first optimization model is solved by using the beamforming parameter as the optimization variable. When step A refers to step A in the first iteration process and step A is performed before step B in the first iteration process, the given value of the configuration parameter herein may be obtained through simulation. In other words, before step A in the first iteration process is performed, simulation may be performed on the first optimization model, to obtain a feasible solution of the configuration parameter as an initial iterative value for the configuration parameter. In another case, the given value of the configuration parameter herein may be a solution of the configuration parameter that is obtained in step B before step A. The another case herein may include any of the following cases: step A is step A in the first iteration process and step B is performed before step A in the first iteration process, or step A is step A in iteration processes subsequent to the first iteration process.

Step B may include: in a case in which the value of the beamforming parameter is given, solving the first optimization model with the optimization objective of maximizing the secrecy energy efficiency, to determine the value of the configuration parameter.

In other words, in step B, the value of the beamforming parameter may be fixed, and the first optimization model is solved by using the configuration parameter as the optimization variable. When step B refers to step B in the first iteration process and step B is performed before step A in the first iteration process, the given value of the beamforming parameter herein may be obtained through simulation. In other words, before step B in the first iteration process is performed, simulation may be performed on the first optimization model, to obtain a feasible solution of the beamforming parameter as an initial iterative value for the beamforming parameter. In another case, the given value of the beamforming parameter herein may be a solution of the beamforming parameter that is obtained in step A before step B. The another case herein may include any of the following cases: step B is step B in the first iteration process and step Ais performed before step B in the first iteration process, or step B is step B in iteration processes subsequent to the first iteration process.

Each time an iteration process including step A and step B is completed, it may be determined whether an iteration stopping condition is met. If the iteration stopping condition is not met, the iteration process including step A and step B may be performed continuously. If the iteration stopping condition is met, a value of the configuration parameter and a value of the beamforming parameter in the current iteration process may be output as an optimal solution of the first optimization model.

The iteration stopping condition herein may include either or both of an iteration convergence condition and an iteration timeout condition. For example, a threshold (which is referred to as a first threshold below) may be set, and when a quotient obtained after a difference between the secrecy energy efficiency obtained in the current iteration process and the secrecy energy efficiency obtained in the previous iteration process is divided by the secrecy energy efficiency obtained in the previous iteration process is less than or equal to the first threshold, it may be considered that the iteration convergence condition is met. For another example, a iteration count threshold (which is referred to as a second threshold below) may be set, and when a quantity of times that the iteration process including step A and step B is performed is greater than or equal to the second threshold, it is considered that the iteration timeout condition is met. In actual application, the iteration convergence condition and the iteration timeout condition may be set simultaneously. When either the iteration convergence condition or the iteration timeout condition is met, it may be considered that the iteration stopping condition is met.

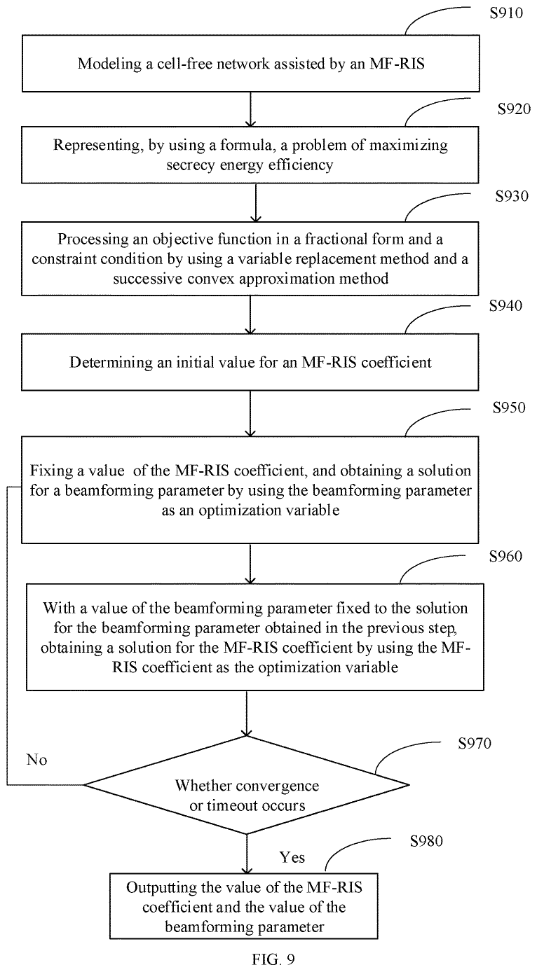

A cell-free network assisted by an MF-RIS is used as an example below, and how to solve an MF-RIS coefficient and a beamforming parameter by using a method provided in embodiments of the present application is described with reference to FIG. 9. As shown in FIG. 9, a method for wireless communication according to an embodiment of the present application may include the following steps S910 and S980.

In step S910, a cell-free network assisted by an MF-RIS is modeled.

In step S920, a problem of maximizing secrecy energy efficiency is represented by using a formula.

In step S930, an objective function in a fractional form and a constraint condition are processed by using a variable replacement method and a successive convex approximation method.

In step S940, an initial value for an MF-RIS coefficient is determined.

In step S950, a value of the MF-RIS coefficient is fixed, and a solution for a beamforming parameter is obtained by using the beamforming parameter as an optimization variable.

In step S960, with the beamforming parameter fixed to the solution for the beamforming parameter obtained in the previous step, a solution for the MF-RIS coefficient is obtained by using the MF-RIS coefficient as the optimization variable.

In step S970, it is determined whether an iteration convergence or timeout occurs. If no iteration convergence or timeout occurs, the method returns to step S950. If the iteration convergence or timeout occurs, step S980 is performed.

In step S980, the value of the beamforming parameter obtained in step S950 of the current iteration process and the value of the MF-RIS coefficient obtained in step S960 of the current iteration process are output as an optimal solution.

To facilitate understanding of the process of solving the first optimization model, an example in which the first optimization model is

$$\frac{{\sum }_{b ∈ B} {R}_{b}^{s}}{{P}_{T}} ,$$

the first optimization objective is to maximize

$$\frac{{\sum }_{b ∈ B} {R}_{b}^{s}}{{P}_{T}} ,$$

the optimization variable is w_{b} and Θₖ, and the first constraint condition includes

$${\sum }_{b ∈ B} {‖ {w}_{a b} ‖}^{2} \leq {P}_{A P}^{max} , {P}_{RIS}^{O} + {\sum }_{k ∈ K} {σ}_{0}^{2} {‖ {Θ}_{k} ‖}_{F}^{2} \leq {P}_{RIS}^{max} , {\sum }_{k ∈ K} {β}_{m}^{k} \leq {β}_{max} ,$$

$${β}_{m}^{k} ∈ [ 0 , {β}_{max} ] , {θ}_{m}^{k} ∈ [ 0 , 2 π ) ,$$

and R_{b}≥Rₘᵢₙ is used below to describe in detail processes of converting the first optimization model in the first processing manner and solving the first optimization model.

To process the first optimization model in a fractional form, slack variables ζ, ρ, and r may be first introduced to convert the first optimization model to:

$${max}_{\{ {w}_{b} , {Θ}_{k} \} , ζ , ρ , r} ζ$$

$$s . t . {\sum }_{b ∈ B} ( {r}_{b} - {r}_{e b} ) \geq ζ ρ , ∀ e ∈ E ,$$

$${P}_{T} \leq ρ ,$$

$${R}_{b} \geq {r}_{b} , ∀ b ∈ B ,$$

$${R}_{e b} \leq {r}_{e} , ∀ b ∈ B , ∀ e ∈ E ,$$

$${r}_{b} \geq {R}_{min} , ∀ b ∈ B ,$$

$${\sum }_{b ∈ B} {‖ {w}_{a b} ‖}^{2} \leq {P}_{A P}^{max} , ∀ a ∈ A ,$$

$${P}_{RIS}^{O} + {\sum }_{k ∈ K} {σ}_{0}^{2} {‖ {Θ}_{k} ‖}_{F}^{2} \leq {P}_{RIS}^{max} ,$$

$${\sum }_{k ∈ K} {β}_{m}^{k} \leq {β}_{max} , ∀ m ∈ M ,$$

$${β}_{m}^{k} ∈ [ 0 , {β}_{max} ] , {θ}_{m}^{k} ∈ [ 0 , 2 π ) , ∀ k ∈ K , ∀ m ∈ M ,$$

where r={r_{b}, r_{eb}|Λb∈B, Λe∈E}. Because constraints Σ_{b∈B}(r_{b}−r_{eb})≥ξ(ρ, ∇e∈E, and P_{T}≤ρ are active at an optimal solution, the converted problem is equivalent to the original problem.

Further, to simplify a complex logarithmic form in constraint conditions R_{b}≥r_{b}, Λb∈B, and R_{eb}≤rₑ, Λb∈B, Λe∈E and simplify an expression of a signal to interference plus noise ratio in a fractional form, an auxiliary variable set Δ={η_{b}, η_{eb}, S_{b}, S_{eb}, I_{b}, I_{eb}|∇b∈B,∇e∈E} may be introduced, where

$${{η}_{b} = {log}_{2} ( 1 + {S}_{b}^{- 1} {I}_{b}^{- 1} ) , {η}_{e b} = {log}_{2} ( 1 + {S}_{e b}^{- 1} {I}_{e b}^{- 1} ) , {S}_{b} = \vert {\overline{h}}_{b}^{H} {w}_{b} \vert}^{2} ,$$

$${S}_{e b} = \vert {\overline{h}}_{e}^{H} {w}_{b} {\vert}^{2} , {I}_{b} = {\sum }_{j = 1 , j \neq b}^{B} {\vert {\overline{h}}_{b}^{H} {w}_{j} \vert}^{2} + {\sum }_{k ∈ K} {σ}_{0}^{2} {‖ {g}_{s b}^{H} {Θ}_{k} ‖}^{2} + {σ}_{1}^{2} , and$$

$${I}_{e b} = {\sum }_{j = 1 , j \neq b}^{B} {\vert {\overline{h}}_{e}^{H} {w}_{j} \vert}^{2} + {\sum }_{k ∈ K} {σ}_{0}^{2} {‖ {g}_{s e}^{H} k ‖}^{2} + {σ}_{2}^{2} .$$

Therefore, the first optimization model may be reconstructed as:

$${max}_{\{ {w}_{b ,} {Θ}_{k} \} , {Δ}_{1}} ζ$$

$$s . t . {η}_{b} \geq {r}_{b} , {η}_{e b} \leq {r}_{e b} , ∀ b ∈ B , ∀ e ∈ E ,$$

$${η}_{b} \leq {log}_{2} ( 1 + {S}_{b}^{- 1} {I}_{b}^{- 1} ) , ∀ b ∈ B ,$$

$${η}_{e b} \geq {log}_{2} ( 1 + {S}_{e b}^{- 1} {I}_{e b}^{- 1} ) , ∀ b ∈ B , ∀ e ∈ E ,$$

$${S}_{b}^{- 1} \leq {\vert {\overline{h}}_{b}^{H} {w}_{b} \vert}^{2} , ∀ b ∈ B ,$$

$${S}_{e b}^{- 1} \geq {\vert {\overline{h}}_{e}^{H} {w}_{b} \vert}^{2} ∀ b ∈ B , ∀ e ∈ E ,$$

$${I}_{b} \geq {\sum }_{j = 1 , j \neq b}^{B} {\vert {\overline{h}}_{b}^{H} {w}_{j} \vert}^{2} + {\sum }_{k ∈ K} {σ}_{0}^{2} {‖ {g}_{s b}^{H} k ‖}^{2} + {σ}_{1}^{2} , ∀ b ∈ B ,$$

$${I}_{e b} \leq {\sum }_{j = 1 , j \neq b}^{B} {\vert {\overline{h}}_{e}^{H} {w}_{j} \vert}^{2} + {\sum }_{k ∈ K} {σ}_{0}^{2} {‖ {g}_{s e}^{H} k ‖}^{2} + {σ}_{2}^{2} , ∀ b ∈ B , ∀ e ∈ E ,$$

$${\sum }_{b ∈ B} {‖ {w}_{a b} ‖}^{2} \leq {P}_{A P}^{max} , ∀ a ∈ A ,$$

$${P}_{RIS}^{O} + {\sum }_{k ∈ K} {σ}_{0}^{2} {‖ {Θ}_{k} ‖}_{F}^{2} \leq {P}_{RIS}^{max} ,$$

$${\sum }_{k ∈ K} {β}_{m}^{k} \leq {β}_{max} , ∀ m ∈ M ,$$

$${β}_{m}^{k} ∈ [ 0 , {β}_{max} ] , {θ}_{m}^{k} ∈ [ 0 , 2 π ) , ∀ k ∈ K , ∀ m ∈ M ,$$

$${\sum }_{b ∈ B} ( {r}_{b} - {r}_{e b} ) \geq ζ ρ , ∀ e ∈ E ,$$

$${P}_{T} \leq ρ ,$$

$${r}_{b} \geq {R}_{min} , ∀ b ∈ B ,$$

where Δ₁={ζ,ρ,r,Δ}, and constraints [symbol] (r_{b}−r_{eb})≥ζρ, ∇e∈E and

$${η}_{n} \leq {log}_{2} ( 1 + {S}_{b}^{- 1} {I}_{b}^{- 1} ) ,$$

∇b∈B are non-convex due to the product term ζρ and the logarithm term

$${log}_{2} ( 1 + {S}_{b}^{- 1} {I}_{b}^{- 1} ) .$$

Herein, the constraints may be approximated by using a successive convex approximation method. At given points

$$\{ {ζ}^{( ℓ )} , {ρ}^{( ℓ )} \} and \{ {S}_{b}^{( ℓ )} , {I}_{b}^{( ℓ )} \}$$

in the [symbol] ^{th} iteration, the linear approximation of these terms may be as follows:

$${( ζ ρ )}^{L N} = ζ {ρ}^{( ℓ )} + {ζ}^{( ℓ )} ρ - {ζ}^{( ℓ )} {ρ}^{( ℓ )} ,$$

$${R}_{b}^{L N} = {log}_{2} ( 1 + \frac{1}{{S}_{b}^{( ℓ )} {I}_{b}^{( ℓ )}} ) - \frac{( {log}_{2} e ) ( {S}_{b} - {S}_{b}^{( ℓ )} )}{{S}_{b}^{( ℓ )} + {( {S}_{b}^{( ℓ )} )}^{2} {I}_{b}^{( ℓ )}} - \frac{( {log}_{2} e ) ( {I}_{b} - {I}_{b}^{( ℓ )} )}{{I}_{b}^{( ℓ )} + {( {I}_{b}^{( ℓ )} )}^{2} {S}_{b}^{( ℓ )}} .$$

Finally, the original optimization problem may be rewritten as:

$${max}_{\{ {w}_{b} , {Θ}_{k} \} , {Δ}_{1}} ζ$$

$$s . t . {η}_{b} \geq {r}_{b} , {η}_{e b} \leq {r}_{e b} , ∀ b ∈ B , ∀ e ∈ E ,$$

$${\sum }_{b ∈ B} ( {r}_{b} - {r}_{e b} ) \geq {( ζ ρ )}^{L N} , ∀ e ∈ E ,$$

$${η}_{b} \leq {R}_{b}^{L N} , ∀ b ∈ B ,$$

$${\sum }_{b ∈ B} {‖ {w}_{a b} ‖}^{2} \leq {P}_{A P}^{max} , ∀ a ∈ A ,$$

$${P}_{RIS}^{O} + {\sum }_{k ∈ K} {σ}_{0}^{2} {‖ {Θ}_{k} ‖}_{F}^{2} \leq {P}_{M S}^{max} ,$$

$${\sum }_{k ∈ K} {β}_{m}^{k} \leq {β}_{max} , ∀ m ∈ M ,$$

$${β}_{m}^{k} ∈ [ 0 , {β}_{max} ] , {θ}_{m}^{k} ∈ [ 0 , 2 π ) , ∀ k ∈ K , ∀ m ∈ M ,$$

$${P}_{T} \leq ρ ,$$

$${r}_{b} \geq {R}_{min} , ∀ b ∈ B ,$$

$${η}_{e b} \geq {log}_{2} ( 1 + {S}_{e b}^{- 1} {I}_{e b}^{- 1} ) , ∀ b ∈ B , ∀ e ∈ E ,$$

$${S}_{b}^{- 1} \leq {\vert {\overline{h}}_{b}^{H} {w}_{b} \vert}^{2} , ∀ b ∈ B ,$$

$${S}_{e b}^{- 1} \geq {\vert {\overline{h}}_{e}^{H} {w}_{b} \vert}^{2} , ∀ b ∈ B , ∀ e ∈ E ,$$

$${I}_{b} \geq {\sum }_{j = 1 , j \neq b}^{B} {\vert {\overline{h}}_{b}^{H} {w}_{j} \vert}^{2} + {\sum }_{k ∈ K} {σ}_{0}^{2} ‖ {g}_{s b}^{H} {Θ}_{k} {‖}^{2} + {σ}_{1}^{2} , ∀ b ∈ B ,$$

$${I}_{e b} \leq {\sum }_{j = 1 , j \neq b}^{B} {\vert {\overline{h}}_{e}^{H} {w}_{j} \vert}^{2} + {\sum }_{k ∈ K} {σ}_{0}^{2} {‖ {g}_{s e}^{H} {Θ}_{k} ‖}^{2} + {σ}_{2}^{2} , ∀ b ∈ B , ∀ e ∈ E .$$

The beamforming parameter w_{b} and the MF-RIS coefficient Θₖ may be iteratively optimized by using the variable replacement method, so as to solve the non-convex nonlinear optimization problem described above.

First, the MF-RIS coefficient Θₖ may be fixed, so as solve the beamforming parameter w_{b}. Before the solving is performed, matrixes

$${\overline{H}}_{b} = {\overline{h}}_{b}^{H} {\overline{h}}_{b} , {\overline{H}}_{e} = {\overline{h}}_{e}^{H} {\overline{h}}_{e} , and {W}_{b} = {w}_{b} {w}_{b}^{H}$$

may be defined, where W_{b}±0 and Rank(W_{b})=1 are met. Therefore, the optimization problem of the first optimization model may be equivalently converted to:

$${max}_{\{ {w}_{b} \} , {Δ}_{1}} ζ$$

$$s . t . {η}_{b} \geq {r}_{b} , {η}_{e b} \leq {r}_{e b} , ∀ b ∈ B , ∀ e ∈ E ,$$

$${\sum }_{b ∈ B} T r ( {A}_{a} {W}_{b} ) \leq {P}_{A P}^{max} , ∀ a ∈ A ,$$

$${P}_{RIS}^{O} ( {W}_{b} ) + {\sum }_{k ∈ K} {σ}_{0}^{2} {‖ {Θ}_{k} ‖}_{F}^{2} \leq {P}_{RIS}^{max} ,$$

$${P}_{T} ( {W}_{b} ) \leq ρ ,$$

$${η}_{e b} \geq {log}_{2} ( 1 + {S}_{e b}^{- 1} {I}_{e b}^{- 1} ) , ∀ b ∈ B , ∀ e ∈ E ,$$

$${S}_{b}^{- 1} \leq T r ( {\overline{H}}_{b} {W}_{b} ) , ∀ b ∈ B ,$$

$${S}_{e b}^{- 1} \geq T r ( {\overline{H}}_{e} {W}_{b} ) , ∀ b ∈ B , ∀ e ∈ E ,$$

$${I}_{b} \geq {\sum }_{j = 1 , j \neq b}^{B} T r ( {\overline{H}}_{b} {W}_{j} ) + {\sum }_{k ∈ K} {σ}_{0}^{2} {‖ {g}_{s b}^{H} {Θ}_{k} ‖}^{2} + {σ}_{1}^{2} , ∀ b ∈ B ,$$

$${I}_{e b} \leq {\sum }_{j = 1 , j \neq b}^{B} T r ( {\overline{H}}_{e} {W}_{j} ) + {\sum }_{k ∈ K} {σ}_{0}^{2} {‖ {g}_{s e}^{H} {Θ}_{k} ‖}^{2} + {σ}_{2}^{2} , ∀ b ∈ B , ∀ e ∈ E ,$$

$${W}_{b} \pm 0 , Rank ( {W}_{b} ) = 1 , ∀ b ∈ B ,$$

$${r}_{b} \geq {R}_{min} , ∀ b ∈ B ,$$

$${\sum }_{b ∈ B} ( {r}_{b} - {r}_{e b} ) \geq {( ζ ρ )}^{L N} , ∀ e ∈ E ,$$

$${η}_{b} \leq {R}_{b}^{L N} , ∀ b ∈ B ,$$

where

$${A}_{a} = Δ diag ( {\underbrace{0 , … , 0}}_{( a - 1 ) N} , {\underbrace{1 , … , 1}}_{N} , {\underbrace{0 , \text{…} , 0}}_{( A - a ) N} ) ,$$

$${P}_{RIS}^{O} ( {W}_{b} ) = {\sum }_{k ∈ K} {\sum }_{a ∈ A} {\sum }_{b ∈ B} Tr ( {Θ}_{k} {G}_{as} {G}_{as}^{H} {Θ}_{k}^{H} {A}_{a} {W}_{b} ) , and$$

$${P}_{T} ( {W}_{b} ) = {δ}_{1} ( {P}_{RIS}^{O} ( {W}_{b} ) + {\sum }_{k ∈ K} {σ}_{0}^{2} {‖ {Θ}_{k} ‖}_{F}^{2} ) + {δ}_{2} {\sum }_{a ∈ A} {\sum }_{b ∈ B} T r ( {A}_{a} {W}_{b} ) + {P}_{C} .$$

Due to a non-convex constrain

$${S}_{e b}^{- 1} \geq Tr ( {\overline{H}}_{e} {W}_{b} ) ,$$

Λb∈B, Λe∈E and a rank-one constraint Rank(W_{b})=1,Λb∈B, the optimization problem is a non-convex optimization problem. By using the successive convex approximation method, at a given point

$$\{ {S}_{eb}^{( ℓ )} \}$$

in the [symbol] ^{th} iteration, a lower bound of

$${S}_{eb}^{- 1}$$

may be represented as

$${( {S}_{eb}^{- 1} )}^{LN} = \frac{2 {S}_{eb}^{( ℓ )} - {S}_{eb}}{{( {S}_{eb}^{( ℓ )} )}^{2}} .$$

Therefore, the constraint may be rewritten to be in the following convex form:

$${( {S}_{eb}^{- 1} )}^{LN} \geq Tr ( {\overline{H}}_{e} {W}_{b} ) , ∀ b ∈ B , ∀ e ∈ E .$$

Based on a semidefinite relaxation method, the rank-one constraint may be directly ignored, to obtain the following relaxation problem:

$${max}_{\{ {W}_{b} \} , {Δ}_{1}} ζ$$

$$s . t . {η}_{b} \geq {r}_{b} , {η}_{eb} \leq {r}_{eb} , ∀ b ∈ B , ∀ e ∈ E ,$$

$${W}_{b} \pm 0 , ∀ b ∈ B ,$$

$${r}_{b} \geq {R}_{min} , ∀ b ∈ B ,$$

$${\sum }_{b ∈ B} ( {r}_{b} - {r}_{eb} ) \geq {( ζ ρ )}^{LN} , ∀ e ∈ E ,$$

$${η}_{b} \leq {R}_{b}^{LN} , ∀ b ∈ B ,$$

$${\sum }_{b ∈ B} Tr ( {A}_{a} {W}_{b} ) \leq {P}_{AP}^{max} , ∀ a ∈ A ,$$

$${P}_{RIS}^{O} ( {W}_{b} ) + {\sum }_{k ∈ K} {σ}_{0}^{2} {‖ k ‖}_{F}^{2} \leq {P}_{RIS}^{max} ,$$

$${P}_{T} ( {W}_{b} ) \leq ρ ,$$

$${η}_{eb} \geq {log}_{2} ( 1 + {S}_{eb}^{- 1} {I}_{eb}^{- 1} ) , ∀ b ∈ B , ∀ e ∈ E ,$$

$${S}_{b}^{- 1} \leq Tr ( {\overline{H}}_{b} {W}_{b} ) , ∀ b ∈ B ,$$

$${I}_{b} \geq {\sum }_{j = 1 , j \neq b}^{B} Tr ( {\overline{H}}_{b} {W}_{j} ) + {\sum }_{k ∈ K} {σ}_{0}^{2} {‖ {g}_{sb}^{H} {Θ}_{k} ‖}^{2} + {σ}_{1}^{2} , ∀ b ∈ B ,$$

$${I}_{eb} \leq {\sum }_{j = 1 , j \neq b}^{B} Tr ( {\overline{H}}_{e} {W}_{j} ) + {\sum }_{k ∈ K} {σ}_{0}^{2} {‖ {g}_{se}^{H} {Θ}_{k} ‖}^{2} + {σ}_{2}^{2} , ∀ b ∈ B , ∀ e ∈ E ,$$

$${( {S}_{eb}^{- 1} )}^{LN} \geq Tr ( {\overline{H}}_{e} {W}_{b} ) , ∀ b ∈ B , ∀ e ∈ E .$$

The problem described above is a convex semidefinite programming problem, and therefore, an existing convex optimization tool such as a convex optimization tool kit (convex, CVX) in Matlab software may be used to effectively solve the problem. The following proves that a solution obtained by solving the relaxation problem meets the rank-one constraint.

The above optimization problem after relaxation is jointly convex with respect to the beamforming parameter {W_{b}|Λb}, and therefore, an optimal solution thereof may be represented by using the Karush-Kuhn-Tucker Condition. A Lagrangian function of the aforementioned optimization problem with respect to the beamforming parameter {W_{b}|Λb} may be represented as:

$$\begin{matrix}L = - {\sum }_{a ∈ A} {\sum }_{b ∈ B} ( {λ}_{ab} + {δ}_{2} {v}_{ab} ) Tr ( {A}_{a} {W}_{b} ) \\ - {\sum }_{k ∈ K} {\sum }_{a ∈ A} {\sum }_{b ∈ B} ( {χ}_{kab} + {δ}_{1} {μ}_{kab} ) Tr ( {Θ}_{k} {G}_{as} {G}_{as}^{H} {Θ}_{k}^{H} {A}_{a} {W}_{b} ) \\ + {\sum }_{b ∈ B} {\overline{ω}}_{b} Tr ( {\overline{H}}_{b} {W}_{b} ) - {\sum }_{b ∈ B} {\sum }_{j = 1 , j \neq b}^{B} {ω}_{bj} Tr ( {\overline{H}}_{b} {W}_{j} ) \\ + {\sum }_{b ∈ B} {\sum }_{e ∈ E} {\sum }_{j = 1 , j \neq b}^{B} {ω}_{bej} Tr ( {\overline{H}}_{e} {W}_{j} ) \\ + {\sum }_{b ∈ B} Tr ( {Y}_{b} {W}_{b} ) - {\sum }_{b ∈ B} {\sum }_{e ∈ E} {\overline{ω}}_{be} Tr ( {\overline{H}}_{b} {W}_{b} ) + Γ ,\end{matrix}$$

where λ_{ab},χ_{kab}, μ_{kab}, v_{ab}, ω̅_{b}, ω_{bj}, ω_{bej} and ω̅_{be} represent Lagrange multipliers. Y_{b} represents a Lagrange multiplier matrix, and r represents all quantities independent of the beamforming parameter. Based on the Karush-Kuhn-Tucker Condition, the optimal solution needs to meet:

$${λ}_{ab} , {χ}_{kab} , {μ}_{kab} , {v}_{ab} , {\overline{ω}}_{b} , {ω}_{bj} , {ω}_{ebj} , {\overline{ω}}_{eb} \geq 0 ,$$

$${Y}_{b}^{*} \pm 0 ,$$

$${Y}_{b}^{*} {W}_{b}^{*} = 0 ,$$

$${∇}_{{W}_{b}^{*}} L = 0 ,$$

where

$${λ}_{ab}^{*} , {χ}_{kab}^{*} , {μ}_{kab}^{*} , {v}_{ab}^{*} , {\overline{ω}}_{b}^{*} , {ω}_{bj}^{*} and {ω}_{bej}^{*}$$

represent optimal Lagrange multipliers, and

$${∇}_{{W}_{b}^{*}} L$$

represents a gradient of the Lagrangian function with respect to the beamforming parameter. Based on

$${∇}_{{W}_{b}^{*}} L = 0 ,$$

the following may be obtained:

$${Y}_{b}^{*} = {\sum }_{a ∈ A} ( {λ}_{ab} + {δ}_{2} {v}_{ab} ) {A}_{a} - {Q}_{b}^{*} ,$$

where

$${Q}_{b}^{*} = - {\sum }_{k ∈ K} {\sum }_{a ∈ A} ( {χ}_{kab} + {δ}_{1} {μ}_{kab} ) ( {Θ}_{k} {G}_{as} {G}_{as}^{H} {Θ}_{k}^{H} {A}_{a} ) + {\overline{ω}}_{b} {\overline{H}}_{b} - {\sum }_{j = 1 , j \neq b}^{B} {ω}_{bj} {\overline{H}}_{b} + {\sum }_{e ∈ E} {\sum }_{j = 1 , j \neq b}^{B} {ω}_{bej} {\overline{H}}_{e} - {\sum }_{e ∈ E} {\overline{ω}}_{b e} {\overline{H}}_{b} .$$

Because the matrix

$${Y}_{b}^{*}$$

is positive semidefinite,

$$Rank ( {Y}_{b}^{*} ) = N - 1$$

is valid. In addition, an equation

$${Y}_{b}^{*} {W}_{b}^{*} = 0$$

indicates that an inequality Rank

$$Rank ( {W}_{b}^{*} ) + Rank ( {Y}_{b}^{*} ) \leq N$$

is met. Because

$$Rank ( {W}_{b}^{*} ) = 0$$

cannot meet a minimum rate requirement R_{b}≥Rₘᵢₙ, ∇b∈B,

$$Rank ( {W}_{b}^{*} ) = 1$$

is valid, that is, the rank-one constraint is met.

Next, the beamforming parameter may be given, and the MF-RIS coefficient is solved. For ease of calculation, a matrix

$${V}_{k} = {ν}_{k} {ν}_{k}^{H}$$

may be defined, where the vector

$${ν}_{k} = {[ \sqrt{{β}_{1}^{k}} {e}^{j {θ}_{1}^{k}} , \sqrt{{β}_{2}^{k}} {e}^{j {θ}_{2}^{k}} , … , \sqrt{{β}_{M}^{k}} {e}^{j {θ}_{M}^{k}} , 1 ]}^{H} ,$$

and satisfies

$${V}_{k} \pm 0 , Rank ( {V}_{k} ) = 1 , {[ {V}_{k} ]}_{m , m} = {β}_{m}^{k} ,$$

and [Vₖ]_{M+1,M+1}=1. Therefore, the following equation may be obtained:

$${\vert {\overline{h}}_{c}^{H} {w}_{b} \vert}^{2} = T r ( {C}_{c} {W}_{b} {C}_{c}^{H} {V}_{k} ) , ∀ c ∈ \{ b , e \} ,$$

$${σ}_{0}^{2} {‖ {g}_{s c}^{H} {Θ}_{k} ‖}^{2} = T r ( {D}_{s c} {V}_{k} ) , ∀ c ∈ \{ b , e \} ,$$

$${‖ {Θ}_{k} {G}_{a s} {w}_{a b} ‖}^{2} = T r ( {E}_{a b} {V}_{k} ) ,$$

$${σ}_{0}^{2} {‖ {Θ}_{k} ‖}_{F}^{2} = T r ( F {V}_{k} ) ,$$

where C_{c}, D_{sc}, and E_{ab} respectively meet the following:

$${C}_{c} = [ diag ( {g}_{s c} ) {G}_{1 s} , … , diag ( {g}_{s c} ) {G}_{A s} ; {h}_{1 c}^{H} , … , {h}_{A c}^{H} ] ,$$

$${D}_{s c} = {{σ}_{0}^{2} [ diag ( {g}_{s c} ) ; {0}_{1 \times M} ] [ diag ( {g}_{s c} ) ; {0}_{1 \times M} ]}^{H} ,$$

$${E}_{a b} = {[ {G}_{a s} {w}_{a b} ; 0 ] [ {G}_{a s} {w}_{a b} ; 0 ]}^{H} , F = {{σ}_{0}^{2} [ {I}_{M} ; {0}_{1 \times M} ] [ {I}_{M} ; {0}_{1 \times M} ]}^{H} .$$

Based on the foregoing equations, an optimization problem of the MF-RIS coefficient may be represented as:

$${max}_{\{ {w}_{b} \} , {Δ}_{1}} ζ$$

$$s . t . {η}_{b} \geq {r}_{b} , {η}_{e b} \leq {r}_{e b} , ∀ b ∈ B , ∀ e ∈ E ,$$

$${P}_{RIS}^{O} ( {Θ}_{k} ) + {\sum }_{k ∈ K} T r ( F {V}_{k} ) \leq {P}_{RIS}^{max} ,$$

$${P}_{T} ( {Θ}_{k} ) \leq ρ , ∀ k ∈ K ,$$

$${S}_{b}^{- 1} \leq T r ( {C}_{b} {W}_{b} {C}_{b}^{H} {V}_{k} ) , ∀ b ∈ B ,$$

$${( {S}_{e b}^{- 1} )}^{L N} \geq T r ( {C}_{e} {W}_{b} {C}_{e}^{H} {V}_{k} ) , ∀ b ∈ B , ∀ e ∈ E ,$$

$${I}_{b} \geq {\sum }_{j = 1 , j \neq b}^{B} T r ( {C}_{b} {W}_{j} {C}_{b}^{H} {V}_{k} ) + {\sum }_{k ∈ K} T r ( {D}_{s b} {V}_{k} ) + {σ}_{1}^{2} , ∀ b ∈ B ,$$

$${I}_{e b} \leq {\sum }_{j = 1 , j \neq b}^{B} T r ( {C}_{e} {W}_{j} {C}_{e}^{H} {V}_{k} ) + {\sum }_{k ∈ K} T r ( {D}_{s e} {V}_{k} ) + {σ}_{2}^{2} , ∀ b ∈ B , ∀ e ∈ E ,$$

$${V}_{k} \pm 0 , {[ {V}_{k} ]}_{M + 1 M + 1} = 1 , ∀ k ∈ K ,$$

$${[ {V}_{k} ]}_{m , m =} {β}_{m}^{k} , {β}_{m}^{k} ∈ [ 0 , {β}_{max} ] , ∀ m ∈ M , ∀ k ∈ K ,$$

$$Rank ( {V}_{k} ) = 1 , ∀ k ∈ K ,$$

$${r}_{b} \geq {R}_{min} , ∀ b ∈ B ,$$

$${\sum }_{b ∈ B} ( {r}_{b} - {r}_{e b} ) \geq {( ζ ρ )}^{L N} , ∀ e ∈ E ,$$

$${η}_{b} \leq {R}_{b}^{L N} , ∀ b ∈ B ,$$

where

$${P}_{RIS}^{O} ( {Θ}_{k} ) = {\sum }_{k ∈ K} {\sum }_{a ∈ A} {\sum }_{b ∈ B} T r ( {E}_{a b} {V}_{k} ) , and$$

$${P}_{T} ( {Θ}_{k} ) = {δ}_{1} ( {P}_{RIS}^{O} ( {Θ}_{k} ) + {\sum }_{k ∈ K} Tr ( {FV}_{k} ) ) + {δ}_{2} {\sum }_{a ∈ A} {\sum }_{b ∈ B} {‖ {W}_{a b} ‖}^{2} + {P}_{C} .$$

A difficulty in solving the problem lies in the rank-one constraint Rank(Vₖ)=1, ∇ₖ ∈K. Because a solution for the MF-RIS coefficient that is obtained by solving the relaxation problem does not necessarily meet the rank-one constraint, the constraint cannot be directly ignored. In addition, the constraint may be processed by using a sequential rank-one constraint relaxation method. A rank-one constraint in the [symbol] ^{th} iteration may be rewritten as:

$${ε}_{max} ( {V}_{k} ) \geq {\tilde{n}}^{( ℓ )} T r ( {V}_{k} ) ,$$

where εₘₐₓ(Vₖ) represents a maximum eigenvalue of Vₖ, and [symbol] represents a relaxation factor for the [symbol] ^{th} iteration. Herein, [symbol] =0 indicates that the rank-one constraint is ignored, and [symbol] indicates that the rank-one constraint holds. Therefore, [symbol] may be increased from 0 to 1, so as to approach a rank-one solution. Due to non-differentiable εₘₐₓ(Vₖ), the constraint described above may be further converted to be in the following linear form:

$${e}_{max}^{H} ( {V}_{k}^{( ℓ )} ) {V}_{k} {e}_{max} ( {V}_{k}^{( ℓ )} ) \geq {\tilde{n}}^{( ℓ )} Tr ( {V}_{k} ) ,$$

where

$${e}_{max} ( {V}_{k}^{( ℓ )} )$$

denotes an eigenvector corresponding to a maximum eigenvalue of

$${V}_{k}^{( ℓ )} .$$

Finally, the above optimization problem may be reconstructed as:

$${max}_{\{ {w}_{b} \} , {Δ}_{1}} ζ$$

$$s . t . {η}_{b} \geq {r}_{b} , {η}_{e b} \leq {r}_{e b} , ∀ b ∈ B , ∀ e ∈ E ,$$

$${P}_{RIS}^{O} ( {Θ}_{k} ) + {\sum }_{k ∈ K} T r ( F {V}_{k} ) \leq {P}_{RIS}^{max} ,$$

$${P}_{T} ( {Θ}_{k} ) \leq ρ , ∀ k ∈ K$$

$${S}_{b}^{- 1} \leq T r ( {C}_{b} {W}_{b} {C}_{b}^{H} {V}_{k} ) , ∀ b ∈ B ,$$

$${( {S}_{e b}^{- 1} )}^{L N} \geq T r ( {C}_{e} {W}_{b} {C}_{e}^{H} {V}_{k} ) , ∀ b ∈ B , ∀ e ∈ E$$

$${I}_{b} \geq {\sum }_{j = 1 , j \neq b}^{B} T r ( {C}_{b} {W}_{j} {C}_{b}^{H} {V}_{k} ) + {\sum }_{k ∈ K} T r ( {D}_{s b} {V}_{k} ) + {σ}_{1}^{2} , ∀ b ∈ B ,$$

$${I}_{e b} \leq {\sum }_{j = 1 , j \neq b}^{B} T r ( {C}_{e} {W}_{j} {C}_{e}^{H} {V}_{k} ) + {\sum }_{k ∈ K} T r ( {D}_{s e} {V}_{k} ) + {σ}_{2}^{2} , ∀ b ∈ B , ∀ e ∈ E ,$$

$${V}_{k} \pm 0 , {[ {V}_{k} ]}_{M + 1 , M + 1} = 1 , ∀ k ∈ K$$

$${[ {V}_{k} ]}_{m , m =} {β}_{m}^{k} , {β}_{m}^{k} ∈ [ 0 , {β}_{max} ] , ∀ m ∈ M , ∀ k ∈ K$$

$${e}_{max}^{H} ( {V}_{k}^{( ℓ )} ) {V}_{k} {e}_{max} ( {V}_{k}^{( ℓ )} ) \geq {\tilde{n}}^{( ℓ )} T r ( {V}_{k} ) , ∀ k ∈ K$$

$${r}_{b} \geq {R}_{min} , ∀ b ∈ B ,$$

$${\sum }_{b ∈ B} ( {r}_{b} - {r}_{e b} ) \geq {( ζ ρ )}^{L N} , ∀ e ∈ E ,$$

$${η}_{b} \leq {R}_{b}^{L N} , ∀ b ∈ B .$$

The problem is a convex semidefinite relaxation problem, and therefore, an existing convex tool (such as a CVX) may be used to effectively solve the problem.

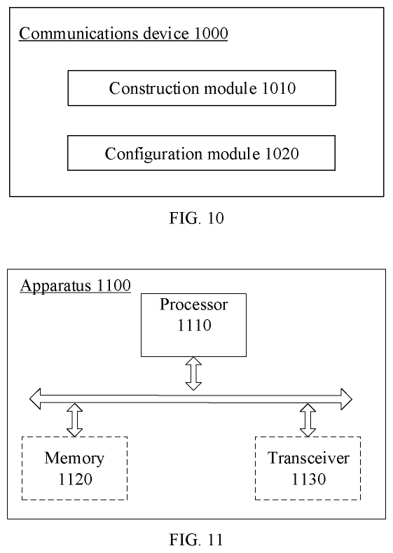

The method embodiments of the present application are described in detail above with reference to FIG. 6 to FIG. 9. Apparatus embodiments of the present application are described in detail below with reference to FIG. 10 and FIG. 11. It should be understood that description of the method embodiments corresponds to description of the apparatus embodiments, and therefore, for parts that are not described in detail, reference may be made to the foregoing method embodiments.

FIG. 10 is a schematic structural diagram of a communications device 1000 according to an embodiment of the present application. The communications device 1000 may be applied to a cell-free network, and the cell-free network may include an access point and an RIS. The communications device 1000 shown in FIG. 10 includes:
a construction module 1010, constructing a first optimization model for the cell-free network, where the first optimization model is used to indicate secrecy energy efficiency of the cell-free network, and an optimization variable of the first optimization model includes a configuration parameter of the RIS and a beamforming parameter of the access point; and
a configuration module 1020, configuring the RIS and the access point based on a solution of the first optimization model.

In some implementations, the configuration module 1020 is further configured to: solve the first optimization model with an optimization objective of maximizing the secrecy energy efficiency, to determine a value of the configuration parameter and a value of the beamforming parameter; and configure the RIS and the access point based on the value of the configuration parameter and the value of the beamforming parameter.

In some implementations, the RIS is used to perform one or more of the following operations: reflecting a signal in the cell-free network, refracting a signal in the cell-free network, or amplifying a signal in the cell-free network.

In some implementations, the construction module is further configured to: construct an achievable secrecy rate model of an authorized user equipment in the cell-free network based on the configuration parameter of the RIS and the beamforming parameter of the access point; construct a power consumption model for the cell-free network based on the configuration parameter of the RIS and the beamforming parameter of the access point; and construct the first optimization model based on the achievable secrecy rate model and the power consumption model.

In some implementations, the construction module is further configured to: determine a first equivalent channel model based on the configuration parameter of the RIS, where the first equivalent channel model is an equivalent channel model from the access point to the authorized user equipment, and the first equivalent channel model includes a channel model from the access point to the authorized user equipment and a channel model from the RIS to the authorized user equipment; determine a second equivalent channel model based on the configuration parameter of the RIS, where the second equivalent channel model is an equivalent channel model from the access point to an unauthorized user equipment in the cell-free network, and the second equivalent channel model includes a channel model from the access point to the unauthorized user equipment and a channel model from the RIS to the unauthorized user equipment; and determine the achievable secrecy rate model based on the beamforming parameter, the first equivalent channel model, and the second equivalent channel model.

In some implementations, the construction module is further configured to: determine a first signal to interference plus noise ratio based on the beamforming parameter and the first equivalent channel model, where the first signal to interference plus noise ratio is a signal to interference plus noise ratio existing when the authorized user equipment demodulates a signal transmitted by the access point to the authorized user equipment; determine a second signal to interference plus noise ratio based on the second equivalent channel model, where the second signal to interference plus noise ratio is a signal to interference plus noise ratio existing when the unauthorized user equipment demodulates the signal transmitted by the access point to the authorized user equipment; and determine the achievable secrecy rate model based on the first signal to interference plus noise ratio and the second signal to interference plus noise ratio.

In some implementations, the optimization objective for the first optimization model is a first optimization objective, a constraint condition of the first optimization model is a first constraint condition, and the configuration module is further configured to: convert the first optimization objective, the first optimization model, and the first constraint condition to a second optimization objective, a second optimization model, and a second constraint condition based on a first processing manner, where the first processing manner includes one or more of the following: introducing a slack variable, introducing an auxiliary variable, performing successive convex approximation on a non-convex constraint, ignoring a rank-one constraint, or using sequential rank-one constraint relaxation.

In some implementations, the configuration module is further configured to: perform step A, where step A includes: in a case in which the value of the configuration parameter is given, solving the first optimization model with the optimization objective of maximizing the secrecy energy efficiency, to determine the value of the beamforming parameter; perform step B, where step B includes: in a case in which the value of the beamforming parameter is given, solving the first optimization model with the optimization objective of maximizing the secrecy energy efficiency, to determine the value of the configuration parameter; and repeatedly perform an iteration process including step A and step B, until the iteration process meets an iteration stopping condition.

In some implementations, the constraint condition of the first optimization model includes one or more of the following: an output power of the access point being less than or equal to a maximum transmit power of the access point, an output power of the RIS being less than or equal to a maximum output power of the RIS, a phase shift of a unit in the RIS being greater than or equal to zero and less than 2π, an amplitude coefficient of the unit in the RIS being less than or equal to a maximum amplitude coefficient, a sum of amplitude coefficients of units in the RIS being less than or equal to the maximum amplitude coefficient, or a rate of the authorized user equipment in the cell-free network meeting a preset minimum rate requirement.

In some implementations, the configuration parameter of the RIS includes the phase shift and the amplitude coefficient of the unit in the RIS.

In some implementations, the beamforming parameter is a precoding vector at the access point for a user equipment in the cell-free network.

FIG. 11 is a schematic structural diagram of a communications apparatus to which an embodiment of the present application is applicable. Dashed lines in FIG. 11 indicate that the unit or module is optional. The apparatus 1100 may be configured to implement a method described in the foregoing method embodiments. The apparatus 1100 may be a chip.

The apparatus 1100 may include one or more processors 1110. The processor 1110 may support the apparatus 1100 in implementing the method described in the foregoing method embodiments. The processor 1110 may be a general-purpose processor or a dedicated processor.

For example, the processor may be a CPU. Alternatively, the processor may be another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1100 may further include one or more memories 1120. The memory 1120 stores a program thereon, and the program may be executed by the processor 1110, so that the processor 1110 executes the method described in the foregoing method embodiments.

The memory 1120 may be separate from the processor 1110 or may be integrated into the processor 1110.

The apparatus 1100 may further include a transceiver 1130. The processor 1110 may communicate with another device or chip by using the transceiver 1130. For example, the processor 1110 may transmit data to and receive data from another device or chip by using the transceiver 1130.

An embodiment of the present application further provides a computer-readable storage medium for storing a program. The computer-readable storage medium may be applied to a device for wireless communication provided in embodiments of the present application, and the program causes a computer to execute a method of embodiments of the present application that is executed by the device for wireless communication.

An embodiment of the present application further provides a computer program product. The computer program product includes a program. The computer program product may be applied to a device for wireless communication provided in embodiments of the present application, and the program causes a computer to execute a method of embodiments of the present application that is executed by the device for wireless communication.

An embodiment of the present application further provides a computer program. The computer program may be applied to a device for wireless communication provided in embodiments of the present application, and the computer program causes a computer to execute a method of embodiments of the present application that is executed by the device for wireless communication.

It should be understood that the terms “system” and “network” in the present application may be used interchangeably. In addition, the terms used in the present application are merely used to explain specific embodiments of the present application, and are not intended to limit the present application. The terms “first”, “second”, “third”, “fourth”, and the like in the description, claims, and accompanying drawings of the present application are used to distinguish between different objects, rather than to describe a specific order. In addition, the terms “include” and “have” and any variations thereof are intended to cover a non-exclusive inclusion.

In embodiments of the present application, “indication” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, “B corresponding to A” means that B is associated with A, and B may be determined based on A. However, it should be further understood that, determining B based on A does not mean determining B based only on A, but instead, B may be determined based on A and/or other information.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined based on functions and internal logic of the processes, and should not be construed as any limitation on the implementation processes of the embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be indirect couplings or communication connections implemented through some interfaces, apparatus, or units, and may be implemented in electronic, mechanical, or other forms.

Units described as separate components may be or may not be physically separate, and components displayed as units may be or may not be physical units, that is, may be located in one place or distributed on a plurality of network units. Some or all of the units may be selected based on actual requirements to achieve objectives of solutions of the embodiments.

In addition, functional units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When the software is used to implement the embodiments, all or some of the embodiments may be implemented in a form of a computer program product. The computer program product includes one or more computer instructions.

When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for wireless communication, wherein and the method comprises:
constructing a first optimization model for a cell-free network, wherein the cell-free network comprises an access point and a reconfigurable intelligence surface (RIS), wherein the first optimization model indicates an energy efficiency of the cell-free network, and an optimization variable of the first optimization model comprises a configuration parameter of the RIS and a beamforming parameter of the access point; and
configuring the RIS and the access point based on a solution of the first optimization model.

2. The method according to claim 1, wherein the configuring of the RIS and the access point based on the solution of the first optimization model comprises:
solving the first optimization model with an optimization objective of maximizing the energy efficiency, to determine a value of the configuration parameter and a value of the beamforming parameter; and
configuring the RIS and the access point based on the value of the configuration parameter and the value of the beamforming parameter.

3. The method according to claim 1, wherein the RIS is used to perform one or more of following operations: reflecting a signal in the cell-free network, refracting a signal in the cell-free network, or amplifying a signal in the cell-free network.

4. The method according to claim 1, wherein the constructing of the first optimization model for the cell-free network comprises:
constructing an achievable rate model of an authorized user equipment in the cell-free network based on the configuration parameter of the RIS and the beamforming parameter of the access point;
constructing a power consumption model for the cell-free network based on the configuration parameter of the RIS and the beamforming parameter of the access point; and
constructing the first optimization model based on the achievable rate model and the power consumption model.

5. The method according to claim 4, wherein the constructing of the achievable rate model of the authorized user equipment in the cell-free network based on the configuration parameter of the RIS and the beamforming parameter of the access point comprises:
determining a first equivalent channel model based on the configuration parameter of the RIS, wherein the first equivalent channel model is an equivalent channel model from the access point to the authorized user equipment, and the first equivalent channel model comprises a channel model from the access point to the authorized user equipment and a channel model from the access point via the RIS to the authorized user equipment;
determining a second equivalent channel model based on the configuration parameter of the RIS, wherein the second equivalent channel model is an equivalent channel model from the access point to an unauthorized user equipment in the cell-free network, and the second equivalent channel model comprises a channel model from the access point to the unauthorized user equipment and a channel model from the access point via the RIS to the unauthorized user equipment; and
determining the achievable rate model based on the beamforming parameter, the first equivalent channel model, and the second equivalent channel model.

6. The method according to claim 5, wherein the determining of the achievable rate model based on the beamforming parameter, the first equivalent channel model, and the second equivalent channel model comprises:
determining a first signal to interference plus noise ratio based on the beamforming parameter and the first equivalent channel model, wherein the first signal to interference plus noise ratio is a signal to interference plus noise ratio existing when the authorized user equipment demodulates a signal transmitted by the access point to the authorized user equipment;
determining a second signal to interference plus noise ratio based on the second equivalent channel model, wherein the second signal to interference plus noise ratio is a signal to interference plus noise ratio existing when the unauthorized user equipment demodulates the signal transmitted by the access point to the authorized user equipment; and
determining the achievable rate model based on the first signal to interference plus noise ratio and the second signal to interference plus noise ratio.

7. The method according to claim 1, wherein an optimization objective for the first optimization model is a first optimization objective, and a constraint condition of the first optimization model is a first constraint condition; and
the solving of the first optimization model with the optimization objective of maximizing the energy efficiency comprises:
converting the first optimization objective, the first optimization model, and the first constraint condition to a second optimization objective, a second optimization model, and a second constraint condition based on a first processing manner, wherein the first processing manner comprises one or more of following: introducing a slack variable, introducing an auxiliary variable, performing successive convex approximation on a non-convex constraint, ignoring a rank-one constraint, or using sequential rank-one constraint relaxation.

8. The method according to claim 2, wherein the solving of the first optimization model with the optimization objective of maximizing the energy efficiency, to determine the value of the configuration parameter and the value of the beamforming parameter comprises:
performing step A, wherein step A comprises: in a case in which the value of the configuration parameter is given, solving the first optimization model with the optimization objective of maximizing the energy efficiency, to determine the value of the beamforming parameter;
performing step B, wherein step B comprises: in a case in which the value of the beamforming parameter is given, solving the first optimization model with the optimization objective of maximizing the energy efficiency, to determine the value of the configuration parameter; and
repeatedly performing an iteration process comprising step A and step B, until the iteration process meets an iteration stopping condition.

9. The method according to claim 1, wherein a constraint condition of the first optimization model comprises one or more of following: an output power of the access point being less than or equal to a maximum transmit power of the access point, an output power of the RIS being less than or equal to a maximum output power of the RIS, a phase shift of a unit in the RIS being greater than or equal to zero and less than 2π, an amplitude coefficient of the unit in the RIS being less than or equal to a maximum amplitude coefficient, a sum of amplitude coefficients of units in the RIS is less than or equal to the maximum amplitude coefficient, or a rate of the authorized user equipment in the cell-free network meeting a preset minimum rate requirement.

10. The method according to claim 1, wherein the configuration parameter of the RIS comprises a phase shift and an amplitude coefficient of a unit in the RIS.

11. The method according to claim 1, wherein the beamforming parameter is a precoding vector at the access point for a user equipment in the cell-free network.

12. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
constructing a first optimization model for a cell-free network, wherein the cell-free network comprises an access point and a reconfigurable intelligence surface (RIS), wherein the first optimization model indicates an energy efficiency of the cell-free network, and an optimization variable of the first optimization model comprises a configuration parameter of the RIS and a beamforming parameter of the access point; and
configuring the RIS and the access point based on a solution of the first optimization model.

13. The apparatus according to claim 12, wherein the configuring of the RIS and the access point based on the solution of the first optimization model comprises:
solving the first optimization model with an optimization objective of maximizing the energy efficiency, to determine a value of the configuration parameter and a value of the beamforming parameter; and
configuring the RIS and the access point based on the value of the configuration parameter and the value of the beamforming parameter.

14. The apparatus according to claim 12, wherein the RIS is used to perform one or more of following operations: reflecting a signal in the cell-free network, refracting a signal in the cell-free network, or amplifying a signal in the cell-free network.

15. The apparatus according to claim 12, wherein the constructing of the first optimization model for the cell-free network comprises:
constructing an achievable rate model of an authorized user equipment in the cell-free network based on the configuration parameter of the RIS and the beamforming parameter of the access point;
constructing a power consumption model for the cell-free network based on the configuration parameter of the RIS and the beamforming parameter of the access point; and
constructing the first optimization model based on the achievable rate model and the power consumption model.

16. The apparatus according to claim 15, wherein the constructing of the achievable rate model of the authorized user equipment in the cell-free network based on the configuration parameter of the RIS and the beamforming parameter of the access point comprises:
determining a first equivalent channel model based on the configuration parameter of the RIS, wherein the first equivalent channel model is an equivalent channel model from the access point to the authorized user equipment, and the first equivalent channel model comprises a channel model from the access point to the authorized user equipment and a channel model from the access point via the RIS to the authorized user equipment;
determining a second equivalent channel model based on the configuration parameter of the RIS, wherein the second equivalent channel model is an equivalent channel model from the access point to an unauthorized user equipment in the cell-free network, and the second equivalent channel model comprises a channel model from the access point to the unauthorized user equipment and a channel model from the access point via the RIS to the unauthorized user equipment; and
determining the achievable rate model based on the beamforming parameter, the first equivalent channel model, and the second equivalent channel model.

17. The apparatus according to claim 16, wherein the determining of the achievable rate model based on the beamforming parameter, the first equivalent channel model, and the second equivalent channel model comprises:
determining a first signal to interference plus noise ratio based on the beamforming parameter and the first equivalent channel model, wherein the first signal to interference plus noise ratio is a signal to interference plus noise ratio existing when the authorized user equipment demodulates a signal transmitted by the access point to the authorized user equipment;
determining a second signal to interference plus noise ratio based on the second equivalent channel model, wherein the second signal to interference plus noise ratio is a signal to interference plus noise ratio existing when the unauthorized user equipment demodulates the signal transmitted by the access point to the authorized user equipment; and
determining the achievable rate model based on the first signal to interference plus noise ratio and the second signal to interference plus noise ratio.

18. The apparatus according to claim 12, wherein an optimization objective for the first optimization model is a first optimization objective, and a constraint condition of the first optimization model is a first constraint condition; and
the solving of the first optimization model with the optimization objective of maximizing the energy efficiency comprises:
converting the first optimization objective, the first optimization model, and the first constraint condition to a second optimization objective, a second optimization model, and a second constraint condition based on a first processing manner, wherein the first processing manner comprises one or more of following: introducing a slack variable, introducing an auxiliary variable, performing successive convex approximation on a non-convex constraint, ignoring a rank-one constraint, or using sequential rank-one constraint relaxation.

19. The apparatus according to claim 13, wherein the solving of the first optimization model with the optimization objective of maximizing the energy efficiency, to determine the value of the configuration parameter and the value of the beamforming parameter comprises:
performing step A, wherein step A comprises: in a case in which the value of the configuration parameter is given, solving the first optimization model with the optimization objective of maximizing the energy efficiency, to determine the value of the beamforming parameter;
performing step B, wherein step B comprises: in a case in which the value of the beamforming parameter is given, solving the first optimization model with the optimization objective of maximizing the energy efficiency, to determine the value of the configuration parameter; and
repeatedly performing an iteration process comprising step A and step B, until the iteration process meets an iteration stopping condition.

20. One or more non-transitory computer-readable media storing computer instructions, that when executed by one or more processors, cause a computer to perform operations comprising:
constructing a first optimization model for a cell-free network, wherein the cell-free network comprises an access point and a reconfigurable intelligence surface (RIS), wherein the first optimization model indicates an energy efficiency of the cell-free network, and an optimization variable of the first optimization model comprises a configuration parameter of the RIS and a beamforming parameter of the access point; and
configuring the RIS and the access point based on a solution of the first optimization model.
